(19) United States
(12) Patent Application Publication
(10) Pub. No.: US 2004/0046353 A1
(43) Pub. Date: Mar. 11, 2004

(54) Quick release for bicycle axle fastener with multiple locking positions

(76) Inventor: John Neugent, San Luis Obispo, CA (US)

Correspondence Address: Edward E. Roberts, P.O. Box 3206, Dana Point, CA, 92629, US

(21) Appl. No.: 10/656,972

(22) Filed: Sep. 8, 2003

Related U.S. Application Data
(60) Provisional application No. 60/408,311, filed on Sep. 6, 2002.

(51) Int. Cl. B62K 1/00

(52) U.S. Cl. 280/274

(57) ABSTRACT

A quick-release multiple locking position bicycle axle fastener that allows the user to open the cam lever far enough to remove the wheel without having to change the setting on the adjusting nut. The fastener includes a lever operated long travel cam rotating around a cam axle having multiple locking cavities therein for selectively receiving a ball bearing in response to manual movement of a locking and release pin. Depression of the pin releases the lever to rotate about the axle and move the ball bearing from one cavity to another. Positioning of the bearing in a cavity locks the lever in place, one cavity for the closed lever position and multiple cavities for increase opening of the skewer within the bicycle hub. The multiple locking features provide that the wheel stays in a locked position on the fork even if the cam lever is not completely closed. The user must depress the locking and release pin while opening the cam lever making it impossible for the lever to open by mistake or from outside influence.

### CLAIM FOR BENEFIT OF EARLIER FILING DATE

This application claims the benefit of U.S. Provisional Application. No. 60/408,31 1 filed Sep. 6, 2002 entitled “Long Travel Quick Release With Multiple Locking Positions. This application has the same inventor and subject matter as, but a different title from, the aforesaid provisional application.

### BACKGROUND

The background of the invention will be discussed in two parts.

1. Field of the Invention

The invention relates to quick-release bicycle axle fasteners and more particularly to a multiple locking position quick release fastener having a longer travel cam allowing the user to open the cam lever to remove the wheel without changing the setting on the adjusting nut.

2. Description of the Related Art

Bicycle wheels are often attached to bicycles by a bicycle axle fastener that is quickly releasable to allow fast and convenient removal of the wheel. This allows fast replacement of a wheel when a flat tire occurs as well as providing convenient wheel removal for safety attachment to bike racks or for storage. Such conventional quick-release bicycle axle fasteners usually employ a lever-operated cam, often inadvertently left open causing unexpected release of the wheel from the bicycle. However, tabs or bosses have been added to the end of front bicycle fork dropouts so that even if the quick release was open the front wheel could not fall out. This created a problem in that an adjustment nut must be loosened to remove the front wheel. For users not familiar with quick release fasteners this poses a problem, as the nut must be properly adjusted each time the wheel is replaced. This adjustment is often done incorrectly by the inexperienced user, which can result in accidents or other problems due to wheel disengagement. For experienced users this is not a problem, however, the requirement that the nut be adjusted both for wheel removal and installation results in the quick release is no longer as fast as it was before the addition of fork dropout bosses.

Many users get around this problem by filing down the ends of the fork bosses so that the conventional quick release will allow the removal of the wheel without adjusting the nut. This creates a problem in the front wheel can now fall out of the fork if the user did not tighten it properly or if something hits the cam lever to open it.

There are other versions of quick release fasteners that allow for longer travel to open outside of the fork bosses. A related art quick release fastener is disclosed in U.S. Pat. No. 6,260,931 issued to John V. Stewart on Jul. 17, 2001. The disclosed fastener has the addition of a spring such that if the lever-operated cam is left open by the user, the spring causes it to hold the follower against the retaining surface of the dropout, preventing accidental release of the axle. However this is a problem as it is difficult to manufacture a spring with enough tension so that it eliminates the possibility of the wheel falling out without it being too heavy, too large in or too tight for market considerations.

Thus, attempts to solve this problem have not been adequate in that they did not provide features allowing for wheel removal without having to change the setting on the adjusting nut, and/or they were inconvenient, expensive, or had other disadvantages, such as safety problems.

It is thus an aspect of the present invention to provide a quick release fastener that allows the user to open the cam lever far enough to remove the wheel without having to change the setting on the adjusting nut.

It is another aspect of the invention to provide a quick release fastener combining a longer travel cam with a locking mechanism that locks in multiple positions, thereby allowing the user to open the lever far enough to remove the wheel without changing the setting on the adjusting nut.

It is yet another aspect of the invention to provide a quick release fastener having a locking pin that when depressed while opening the cam lever prevents the lever from opening by mistake or by outside influence.

Other aspects, features and advantages of the invention will become apparent from a reading of the specification, when taken in conjunction with the drawings, in which like reference numerals refer to like elements in the several views.

### SUMMARY

In accordance with the present invention there is provided a quick-release multiple locking position bicycle axle fastener that allows the user to open the cam lever far enough to remove the wheel without having to change the setting on the adjusting nut. The fastener includes a lever operated long travel cam rotating around a cam axle having multiple locking cavities therein for selectively receiving a ball bearing in response to manual movement of a locking and release pin. Depression of the pin releases the lever to rotate about the axle and move the ball bearing from one cavity to another. Positioning of the bearing in a cavity locks the lever in place, one cavity for the closed lever position and multiple cavities for increase opening of the skewer within the bicycle hub. The fastener is quick and convenient to operate, requiring only that the user depresses the pin and moves the cam lever as desired from a closed to one of the multiple other locking positions. The multiple locking features provide that the wheel stays in a locked position on the fork even if the cam lever is not completely closed. The user must depress the locking and release pin while opening the cam lever making it impossible for the lever to open by mistake or from outside influence.

### DRAWINGS

FIG. 1 is a perspective view of the quick release for a bicycle axle fastener embodying features of the present invention fastener assembled in the closed position;

FIG. 2 is an exploded perspective view of the quick release fastener shown in FIG. 1;

FIG. 3 is a cross-sectional view of the quick release fastener of FIG. 1 as viewed along line 3-3 thereof;

FIG. 4 is a plan view of the quick release fastener of FIG. 1 illustrating the closed and two open positions of the fastener for clearance of the fork bosses with turning of the cam lever;

FIG. 5 is a perspective view of the quick release fastener of FIG. 1 assembled in the hub of a bicycle with the lever arm 22 in the closed position to secure the front wheel 72 to the forks 70; and

FIG. 6 is a perspective view of the quick release fastener of FIG. 1 assembled in the open cam lever position with a fork and front wheel showing cam travel to clear the fork bosses.

### DESCRIPTION

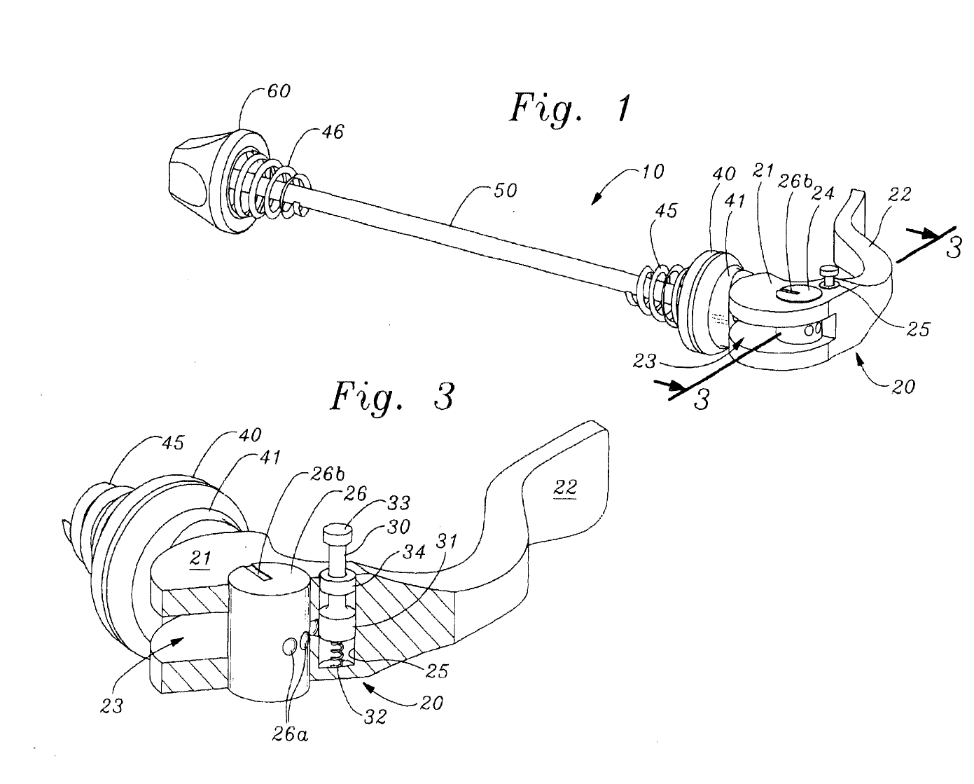

Referring to FIGS. 1-3 the particulars of assembling the long travel cam quick release axle fastener embodying features of the invention will be described. Generally designated 10, the quick release fastener includes the cam lever assembly, generally designated 20, sliding washer 40 with profile washer 41 embedded therein, hub centering springs 45 and 46, skewer shaft 50, and adjustment nut 60. The assembly 20 is shown in the closed position.

For convenience a listing of the reference numerals with a brief description of their function is as follows:

Reference Numerals

10. Quick release fastener generally

20. Cam lever assembly, generally

21. Cam lever head

21a. Long travel cam face of cam lever head 21

22. Cam lever arm

23. Cam lever head cut-out providing threaded access of skewer shaft 50 to cam axle 26

24. Channel in cam lever head 21 for receiving cam axle 26

25. Recess in cam lever head 21 for receiving release pin 30

26. Cam axle with recessed holes 26a

26a. Recessed cavities in cam axle 26 for selectively receiving ball bearing 35

26b. Cam lever position indicator

30. Release pin with raised boss 31 on the base

31. Raised boss on base of release pin 30

32. Release pin spring

33. Pin cushion to cushion release pin 30 when it is pushed

34. Pin collar press fit into channel 25 for retaining release pin 30 in cam lever head 21

35. Ball bearing to engage selected holes 26a in cam axle 26 for locking skewer 50 in various multiple positions

40. Sliding washer

41. Profile washer fitted into sliding washer 40 for coacting with face of cam head 21

45. First center spring that sits outside the hollow axle of hub 71 to center skewer 50

46. Second center spring for centering skewer 50

47. Rubber insert to keep the adjusting nut 60 tightened

50. Skewer shaft

60. Adjusting nut, threads onto end of skewer shaft 50 to adjust skewer 50

70. Front wheel fork tubes

71. Wheel hub

72. Front wheel rim and tire

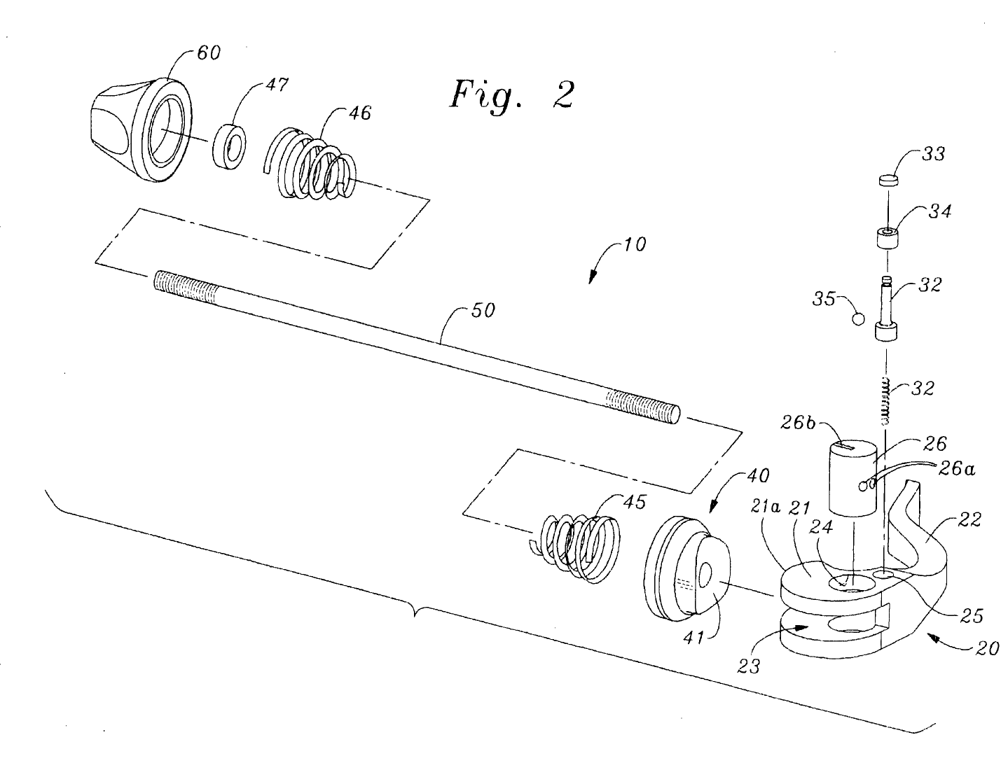

Referring more particularly to FIG. 2 which is an exploded perspective view of FIG. 1, cam lever assembly 20 is shown in detail to comprise cam lever head 21 and cam lever arm 22, cam lever head 21 including a long-travel cam face generally designated 21a, vertical circular channel 24 for receiving circular cam axle 26, vertical circular recess 25 for receiving release pin 30, and a horizontal cut-out 23 extending from the face 21a into channel 24. Cam face 21a is curved in cam-like manner such that coacting with profile washer 41 the combination serves to convert rotary motion of cam lever head 21 into linear motion of skewer 50. It is termed “long travel” in that in operation it provides sufficient linear motion for skewer 50 to clear the bicycle fork bosses. Cam axle 26 includes means, such as threadable, for receiving skewer shaft 50 through cut-out 23, and cavities 26a located for selectively receiving ball bearing 35 therein so as to provide multiple locking positions of cam lever arm 22 as will be further described.

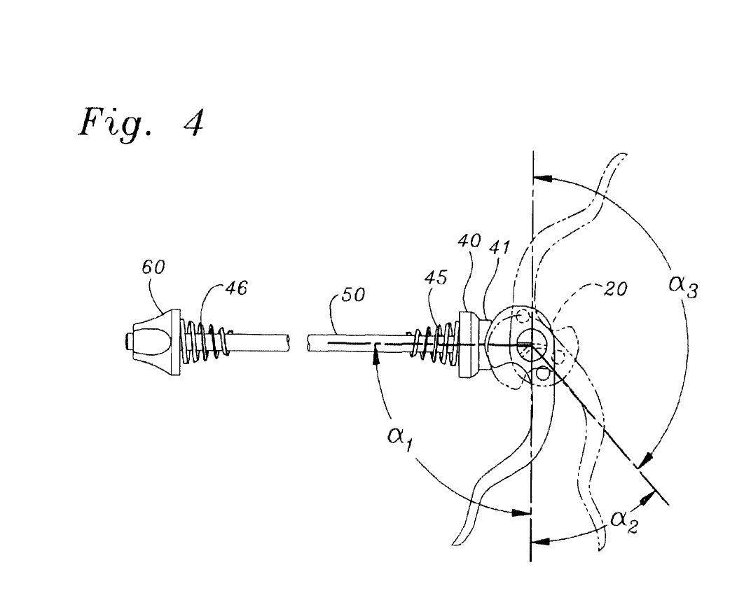

Cut-out 23 extends horizontally into cam head 21 deep enough for connection of skewer shaft 50 to cam axle 26, and laterally to permit motion of cam lever arm 22 about cam axle 26 allowing ball bearing 35 to be selectively positioned in cavities 26a, as will be further discussed. For purposes of explanation three holes are provided to support the three locking positions illustrated in FIG. 4. More or fewer holes could be provided depending upon the number of locking positions desired.

Circular recess 25 is terminated with a floor for receiving in sequence, spring 32, release pin 30, and pin collar 15 that is press fit onto recess 25. Release pin 30 has a raised boss, or base, for contact with spring 32 and a shaft with an end adapted for receiving pin cushion 33 to provide cushioning when release pin 30 is pushed against spring 32. Pushing of release pin 30 depresses spring 32 thereby releasing ball bearing 35 to travel into cam lever head 21 allowing ball bearing 35 to be selectively positioned in a desired one of cavities 26a. When pin 30 is released spring 32 forces raised pin base 31 upward to force ball bearing 35 into a selected position. This is more clearly explained by reference to FIG. 3, a cross-sectional view of FIG. 1 as viewed along line 3-3 thereof.

In FIG. 3 the cam lever arm 22 is shown in the closed or locked position with release pin spring 32 having pushed release pin 30 up so that the release pin base 31 has forced ball bearing 35 into the corresponding closed position cavity of multiple cavities 26a thereby locking lever arm 22 into the closed position. Cam lever arm 22 is locked in this position because the base 31 prevents ball bearing 35 from backing out of the cavity 26a.

To open the lever arm 22 downward pressure is applied to release pin 30 forcing the base 31 downward enough for the ball bearing 35 to fall out of the cavity 26a and into the space above the base 31. Cam lever arm 22 can now be rotated to travel around cam axle 26 and push ball bearing 35 into the cavity corresponding to the first open position. Likewise, ball bearing 35 can be urged into the cavity corresponding to the next open position, or operated to position the cam lever arm 22 in any desired locked position, open or closed. Thus, when the release pin 30 is depressed ball bearing 17 is freed to reenter the channel 24 thereby allowing the lever arm 22 to rotate to a selected position, and then when pin 30 is released lever arm locks into that position.

Cavities 26a are configured such that the ball bearing 35 requires pressure from the base 31 in order to remain therein. When the lever arm 22 is in the open position the release pin 30 is down. To close the lever arm 22 it is moved with pressure on the release pin 30 to keep it down. When the lever arm 22 is in the closed position and the release pin 30 is released it moves up from spring pressure whereby the base 31 forces ball bearing 35 into one of the cavities 26a. Thus, when the lever arm 22 is moved into a closed position release pin 30 pops up under pressure from spring 32. Collar 34 is press fit into channel 25 for retaining release pin 30 therein. Indicator 26b provides visual evidence that skewer 50 is in particular position.

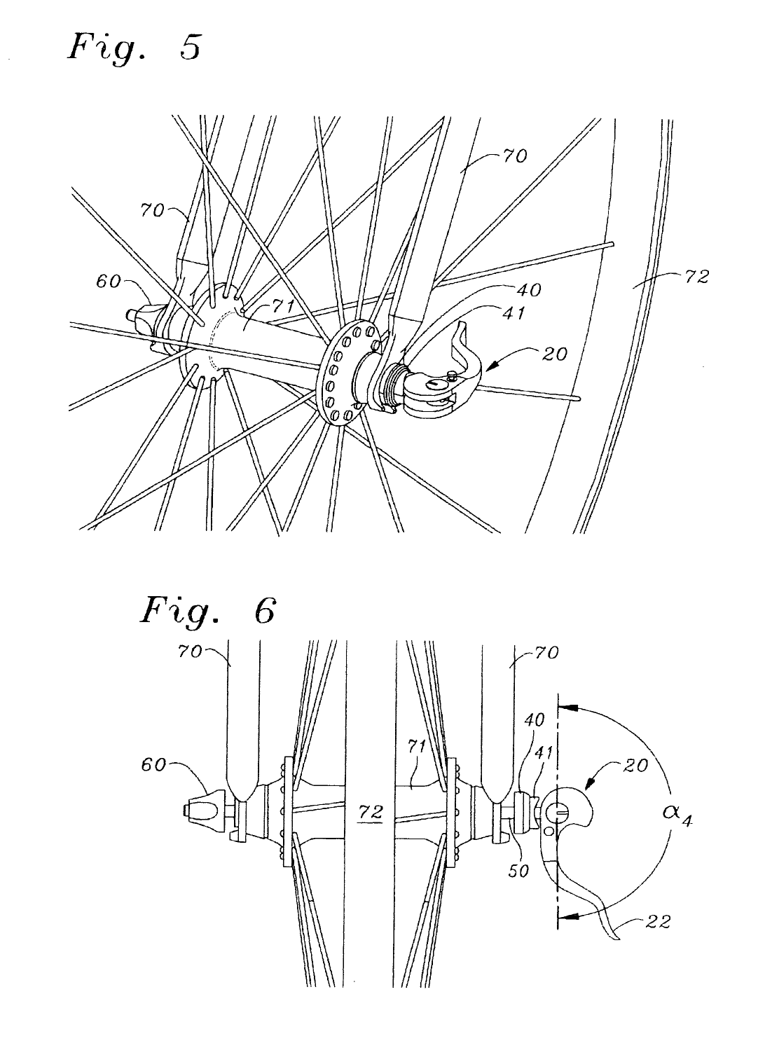

Thus, for assembly of the quick release multiple locking position fastener, the release pin 30 and cam axle 26 are inserted into cam lever head 21 as discussed. Skewer shaft 50 is an elongate circular metallic member threaded on both ends with one end threaded into cam lever head 21. Sliding washer 40 having profile washer 41 fitted therewith is slid over skewer 40 until the face of profile washer 41 is in abutting relation with the face of cam lever head 21. Profile washer 41 is formed generally of a cam thermoplastic compound and embedded in sliding washer 40, which is generally of a metal alloy. Skewer shaft 40 then accepts a first centering spring 45 after which it is inserted through hub 71 of wheel 72 as illustrated in FIGS. 5 and 6. Second centering spring 46 is then slid onto skewer shaft 40 followed by rubber insert 47 and adjustment nut 60. Insert 47, generally of rubber, functions to provide position stability for adjustment nut 60. Further, although not shown, a set screw can be added to the adjustment nut 60 to provide more permanent adjustment.

FIG. 4 is a plan view of the quick release fastener of FIG. 1 illustrating the closed and two open positions of the fastener 10. With cam lever arm 22 positioned sufficiently open, either through angle α₁ or α₂, the cam lever arm 22 is far enough away from the center of wheel hub 71 to allow installation of the wheel 72 between the wheel forks 70 without readjusting nut 60. Thus, clearance of the bosses on front wheel forks 70 is obtained by turning the cam lever arm 22 from the closed α₁ position to the angle α₂ first open position or to the angle α₃ fully open position. Subsequent open positions moves springs 45 and 46 further away from the center of hub 71 allowing increasing room for clearance of the fork bosses so as to mount the wheel 72. After installation of the wheel 72, lever arm 22 is repositioned to force the centering springs 45 and 46 against the bosses of front wheel forks 70 thereby to secure the wheel hub 71 in place.

FIG. 5 is a perspective view of the quick release fastener of FIG. 1 assembled in the hub 71 of a bicycle with the lever arm 22 in the closed position and the adjusting nut 60 tightened to secure the wheel 72 to the forks 70.

FIG. 6 is a perspective view of the quick release fastener of FIG. 1 assembled in the hub 71 with the lever arm 22 in the fully opened position to clear the bosses of forks 70 from the front wheel 72. In this position the wheel 72 can be removed and reinstalled without adjusting the nut 60.

In accordance with the above, there has been shown and described a quick-release long cam lever operated multiple locking fastener that allows the user to open the cam lever to remove the wheel without having to change the setting on the adjusting nut. The appended claims should not be limited to the description of the invention, it to be understood that various other adaptations and modifications may be made within the spirit and scope of the claims.

What is claimed is:

1. An improved cam assembly for comprising:
a cam lever head having a long travel face and a cam lever arm, said cam lever head including a cam axle for rotation thereabout by said cam lever arm and hold and release means cooperative with said cam axle for providing multiple locking positions of rotation of said cam lever arm; and
said cam axle including multiple indentations in said cam axle and said hold and release means including a hold and release pin and a spring whereby under pressure from said spring said hold and release pin forces a ball bearing into a selected one of said multiple indentations thereby locking said lever arm and upon depressing said hold and release pin against said spring said ball bearing is released thereby allowing further movement of said lever arm.

2. An improved quick release fastener for detachable mounting of a hollow wheel hub to the fork of a bicycle, the fastener comprising:
a cam assembly including a cam lever head having a long travel face and a lever arm;
a skewer shaft having a first end, a second end, and a longitudinal axis for insertion through said wheel hub;
an adjustable end nut on said first end of said skewer shaft outside said wheel hub and a profile washer on the other side of said wheel hub adjacent said second end of said skewer, said profile washer adapted for coaction with said long travel face of said cam lever head;
a first hub centering spring on said skewer shaft adjacent said adjustable end nut;
a second hub centering spring on said skewer shaft inward of said profile washer;
said cam lever head includes a cam axle for rotation thereabout by said cam lever arm and hold and release means cooperative with said cam axle for providing multiple locking positions of rotation of said cam lever arm;
said cam axle including multiple cavities and said hold and release means including a pin and a spring whereby said spring urges said pin to force a ball bearing into a selected one of said cavities thereby locking said lever arm and upon depressing said pin against said spring said ball bearing is released thereby allowing movement of said lever arm; and
wherein cooperative operation of said cam lever arm and said hold and release pin provides multiple locking positions for detachable mounting of said wheel hub to said fork.
